(19) United States
(12) Patent Application Publication
(10) Pub. No.: US 2009/0248466 A1
(43) Pub. Date: Oct. 1, 2009

(54) INITIATIVE ANALYZER

(76) Inventor: Jerome Dale JOHNSON, Bayfield, WI (US)

Correspondence Address: Hershkovitz & Associates, LLC, 2845 Duke Street, Alexandria, VA, 22314, US

(21) Appl. No.: 12/206,608

(22) Filed: Sep. 8, 2008

Related U.S. Application Data
(63) Continuation-in-part of application No. 12/055,299, filed on Mar. 25, 2008.
Application No. 12/055,299 is a continuation-in-part of application No. 12/055,301, filed on Mar. 25, 2008.

(51) Int. Cl. G06Q 10/00

(52) U.S. Cl. 705/7; 705/1

(57) ABSTRACT

Methods, systems and computer program products are provided for electronically determining the financial potential for a user for one or more initiatives to display a list of one or more initiatives for one or more prospects and financial potential for the one or more initiatives of each prospect. The methods, systems and computer program products can allow a user to analyze one or more initiatives and view the financial potential for a salesperson and/or the financial benefits for one or more prospects. The methods, systems and computer program products can allow a user to view multiple initiatives that are applicable for one or more prospects. The methods, systems and computer program products provide organization of initiative information and can allow a salesperson to operate in an efficient manner.

### CROSS-REFERENCE TO RELATED APPLICATIONS

This application is a continuation-in part of U.S. patent application Ser. No. 12/055,299, titled “Interactive Smart Game Plan,” filed on Mar. 25, 2008 and U.S. patent application Ser. No. 12/055,301, titled “Initiative Designer,” filed on Mar. 25, 2008, the disclosures of which are expressly incorporated by reference herein in their entireties.

### BACKGROUND OF THE DISCLOSURE

1. Field of the Disclosure

This disclosure relates to systems, methods and computer program products for an initiative analyzer that can determine the financial potential of a user for one or more growth initiatives. The financial potential can be for a salesperson or a customer. The financial potential can be a commission that a salesperson will make in a transaction such as selling a product or a service. The financial potential can also be the value that a customer will obtain when buying a product or a service. However, the systems, methods and computer program products according to the present disclosure can be applicable for other users and other benefits can be obtained.

2. Discussion of Background Information

During the course of a typical day, a salesperson is constantly trying to identify which customers or prospects he should be spending time with in order to initiate, continue or complete a sale. The salesperson is typically trying to maximize his commission and therefore, needs to determine which customers or prospects present the best opportunities.

For example, a retailer can sell multiple products obtained from multiple manufacturers. Thus, for a number of retailers that a salesperson can interact with, there can be thousands of initiatives that the salesperson needs to consider. With so many initiatives, it is easy for a salesperson to misquote a particular figure or provide the wrong information when he is communicating with a particular prospect. He might even miss the opportunity to interact with a prospective customer or at the very least, not focus on the right customer.

Take for example, a person who owns an independent farm equipment dealership that primarily sells FORD® farm equipment (i.e., tractors, plows, etc.). As FORD® does not offer a complete line of equipment required for a farmer, the person's dealership has to sell other manufacturers' products to supplement a FORD® offering. Thus, the person's product lines would include products from multiple manufacturers.

This person could receive initiative marketing collateral from each of the manufacturers whose products he sells to his customers.

Initiative offerings are anything that can be offered to different customers, such as for a first-time buyer (for example, someone who is purchasing FORD® implements for the first time), to users of other manufacturers, such as JOHN DEERE® converts (i.e., a farmer who previously owned a JOHN DEERE® tractor and now purchases a FORD® tractor to replace his JOHN DEERE® tractor). This is just one example of a particular initiative as there can be many different “sale deals.”

Thus, from the scenario presented above, there are typically several hundreds of different initiatives active at any time that the person has to consider.

The person would then try to organize these initiatives in any way that he can, such as via the traditional three-ring binder containing hard copies of information that a salesperson normally uses. This binder would typically be two to three inches thick with all of the different initiatives that are active at any one time. It is not uncommon to have multiple (i.e., 5-10) initiatives from a single manufacturer for any given single month of the year.

When this person schedules a visit with a current customer or a prospect, he would have to review all of the information in his three-ring binder, trying to identify which initiatives are currently available to the customer or prospect with who he had scheduled a visit. If the person wants to do a thorough job of identifying all the initiatives, it could take him hours to leaf through all of the initiatives. However, if he did not spend a couple of hours going through the initiatives, he inevitably would miss an initiative or two and thus would not be putting the best package together for his customer or prospect. Additionally, some of these initiatives that are missed would cause the person to lose the opportunities with other initiatives for himself or for his dealership. Further, the customer or prospect would not obtain the best deal or value/benefit.

In today's environment, a typical independent retail dealership would represent up to 30 different manufacturers. Each manufacturer may have anywhere from 1 to 100 different products being offered via the independent dealership. Thus, the independent retail dealership may be selling potentially 3000 products. The manufacturers may be running several initiatives for each product and thus the number of different initiatives could be well above 10,000.

Independent retail dealerships can have a variety of ways to organize all of the initiatives. Some are still using the traditional three-ring binders while some are using EXCEL® spreadsheets. Still, others may try to publish their initiatives on web portals. One additional challenge is, that all of these methods require the salesperson to search through these initiatives and determine which one applies for any given customer or prospect.

Additionally, there are known systems and methods that assist a salesperson wherein a commission is calculated for that salesperson, but only after a transaction or a sale has been completed. There are no systems and methods that resolve the problems described above and allow the salesperson to focus on relevant initiatives and/or prospects while allowing the salesperson and/or the prospect to see the financial potential or value in a business transaction.

### SUMMARY OF THE DISCLOSURE

The present disclosure provides systems, methods and computer program products for an initiative analyzer that can provide a user, such as a salesperson, the ability to quickly view his list of customers or prospects and see which programs or initiatives apply to each customer or prospect.

In one or more embodiments, the systems, methods or computer program products according to the present disclosure can allow the user to see what incentives are available should the user initiate, continue or complete a transaction with a particular customer.

In one or more embodiments, the systems, methods or computer program products according to the present disclosure can allow the user to determine how to best spend the time, such as which customers he should be focused on in order to initiate, continue or complete a sales transaction.

In one or more embodiments, the systems, methods or computer program products according to the present disclosure can allow the user to ensure that he covers all of the available initiatives that a prospect qualifies for during his execution or completion of the terms of the initiatives, such as, but not limited to, calling the prospect and visiting the prospect.

Thus, the systems, methods or computer program products according to the present disclosure provide an electronic sales tool to assist a salesperson.

Therefore, the systems, methods or computer program products according to the present disclosure can allow the user to at least view multiple incentives, see the value for each prospect, determine which prospect to focus on regarding a specific initiative, and maximize the benefits for any prospects.

The systems, methods or computer program products according to the present disclosure are versatile such that a user can utilize them at a web portal, without other systems, methods or computer program products, or with other systems, methods or computer program products, such as but not limited to, the “Interactive Smart Game Plan,” as disclosed in U.S. patent application Ser. No. 12/055,299, and/or the “Initiative Designer,” as disclosed in U.S. patent application Ser. No. 12/055,301, which are further described below.

The systems, methods or computer program products according to the present disclosure are robust such that they can be generalized for more than one salesperson but can be specific and personalized for an individual salesperson based on the salesperson's needs and potential.

In one aspect, the systems, methods or computer program products according to the present disclosure can operate via at least one of, the world-wide web, a local area network and a wide area network.

In another aspect, the systems, methods or computer program products can utilize one or more input components configured to allow a user to input information and/or requirements for the initiative (even though the user, with respect to the initiative analyzer, can be any person, this user would typically be a salesperson). The terms “user” and “salesperson” are further defined below with respect to the initiative analyzer. However, in this context of the initiative analyzer, the term “user” is used interchangeably with the term “salesperson” when referring to someone who is utilizing the initiative analyzer. Of course, the user is not limited to a salesperson but can be anyone who derives benefits from using the disclosed systems, methods or computer program products. Hereinafter, this particular user will be referred to as the “user” in order to more accurately describe the user and to prevent any confusion with other terminologies.

Conversely, the systems, methods or computer program products for an initiative analyzer according to the present disclosure can include many features as described in the above-mentioned disclosures of the “Interactive Smart Game Plan” and the “Initiative Designer,” which are incorporated herein in their entireties.

For example, the systems, methods or computer program products according to the present disclosure can utilize a single database that contains all of the relevant information. Alternatively, they can utilize multiple databases. The databases can be relational databases and can be the same or similar databases as described in the “Interactive Smart Game Plan” disclosure or the “Initiative Designer” disclosure.

The systems, methods or computer program products according to the present disclosure can operate along with additional components, such as those described in the two above-mentioned disclosures, such as but not limited to, an analytics component configured to analyze the launch and execution process of a growth initiative and to provide indicators generated from usage and activity of the game plan; and an opportunity analyzer component configured to identify and prioritize prospects for a growth initiative.

As is realized from the present disclosure, there is provided a system for electronically determining the financial potential for a user for one or more initiatives having an electronic component configured to display a list of one or more initiatives for one or more prospects and financial potential for the one or more initiatives of each prospect.

The system according to the present disclosure can have one or more of the following features.

The electronic component can be configured to, at least one of:

(a) allow a user to determine which activities, events or terms of the one or more initiatives to complete in order to maximize sales potential;

(b) allow a user to evaluate information categorized by prospects or initiatives; and

(c) view and evaluate the financial potential for a specific prospect from the list of the one or more initiatives.

The financial potential can include at least one of, an incentive, a compensation, a reward and a bonus and the electronic component can be configured to display at least one of, the incentive, the compensation, the reward and the bonus.

The prospect can be a customer, the user can a salesperson and the electronic component can be configured to display at least one of, the financial potential for the salesperson and the financial benefits for the customer.

The activities, events or terms of the one or more initiatives can include at least one of, an action to establish a sale, an action to establish an order, an action to establish an offer, an action to continue a sale, an action to continue an order, an action to continue an offer, an action to complete a sale, an action to complete an order and an action to complete an offer.

The financial potential can be for different roles of an organization across a list of prospects and the electronic component can be configured to display the financial potential for at least one role of the organization for at least one prospect.

The electronic component can be configured to group and display combinations of incentives together to allow the user to evaluate monetary benefits available for a list of prospects.

The electronic component can be configured to allow the user to view multiple currently active initiatives and cross-reference the multiple currently active initiatives to a list of prospects.

The cross-reference can be an indication to the user if more than one currently active initiative exists for a specific prospect and the electronic component can be configured to display the indication to the user.

The initiatives can be from multiple sources of distribution channels and the electronic component can be configured to display the sources of distribution to the user.

The multiple sources of distribution channels can be at least one of, a manufacturer, a distributor, a retailer and a wholesaler and the electronic component can be configured to display the manufacturer, the distributor, the retailer or the wholesaler.

The electronic component can be configured for a web-based system and no additional software is needed.

The electronic component can be configured to obtain initiative information from at least one database.

The at least one database can be a relational database.

The electronic component can be configured to display prospect information and the prospect information can include a collection or a group of accounts or contacts for which an initiative is targeted.

The electronic component can be configured to operate via at least one of, a world-wide web, a local area network and a wide area network.

Still, according to another aspect of the present disclosure, there is provided a method for analyzing one or more initiatives by one or more users including providing a system having an electronic component configured to display a list of one or more initiatives for one or more prospects and financial potential for the one or more initiatives of each prospect; and utilizing the system for electronically determining the financial potential for the user for one or more initiatives.

The method according to the present disclosure can have one or more of the following features.

The method can further include, at least one of (a) determining which activities, events or terms of the one or more initiatives to complete in order to maximize sales potential by using the system; (b) evaluating information categorized by prospects or initiatives by using the system; and (c) viewing and evaluating the financial potential for a specific prospect from the list of the one or more initiatives by using the system.

The financial potential can include at least one of, an incentive, a compensation, a reward and a bonus and the method can further include utilizing the electronic component to display at least one of, the incentive, the compensation, the reward and the bonus.

The prospect can be a customer, the user can a salesperson and the method can further include utilizing the electronic component to display at least one of, the financial potential for the salesperson and the financial benefits for the customer.

The activities, events or terms of the one or more initiatives can include at least one of, an action to establish a sale, an action to establish an order, an action to establish an offer, an action to continue a sale, an action to continue an order, an action to continue an offer, an action to complete a sale, an action to complete an order and an action to complete an offer.

The financial potential can be for different roles of an organization across a list of prospects and the method can further include utilizing the electronic component to display the financial potential for at least one role of the organization for at least one prospect.

The method can further include utilizing the electronic component to group and display combinations of incentives together to allow the user to evaluate monetary benefits available for a list of prospects.

The method can further include utilizing the electronic component to allow the user to view multiple currently active initiatives and cross-reference the multiple currently active initiatives to a list of prospects.

The cross-reference can be an indication to the user if more than one currently active initiative exists for a specific prospect and the method can further include utilizing the electronic component to display the indication to the user.

The initiatives can be from multiple sources of distribution channel and the method can further include utilizing the electronic component to display the sources of distribution to the user.

The multiple sources of distribution channel can be at least one of, a manufacturer, a distributor, a retailer and a wholesaler and the method can further include utilizing the electronic component to display the manufacturer, the distributor, the retailer or the wholesaler.

The electronic component that is utilized for the method can be operated in a web-based system and no additional software is needed.

The electronic component that is utilized for the method can obtain initiative information from at least one database.

The at least one database that is utilized for the method can be a relational database.

The method can further include utilizing the electronic component to display prospect information and the prospect information can include a collection or a group of accounts or contacts for which an initiative is targeted.

The electronic component that is utilized for the method can operate via at least one of, a world-wide web, a local area network and a wide area network.

Still, according to another aspect of the present disclosure, there is provided a computer program product readable by a computer system having computer-executable instructions that when executed cause a processor of the computer system to display information and/or analyze one or more initiatives, the computer program product instructing the computer system to electronically display a list of one or more initiatives for one or more prospects and financial potential for the one or more initiatives of each prospect; and electronically determine the financial potential for the user for one or more growth initiatives.

The computer program product can further include instructions for the computer system to, at least one of, (a) determine which activities, events or terms of the one or more initiatives to complete in order to maximize sales potential; (b) evaluate information categorized by prospects or initiatives; and (c) evaluate and display the financial potential for a specific prospect from the list of the one or more initiatives.

The financial potential can include at least one of, an incentive, a compensation, a reward and a bonus and the computer program product can further include instructions for the computer system to display at least one of, the incentive, the compensation, the reward and the bonus.

The prospect can be a customer, the user can be a salesperson and the computer program product can further include instructions for the computer system to display at least one of, the financial potential for the salesperson and the financial benefits for the customer.

The activities, events or terms of the one or more initiatives can include at least one of, an action to establish a sale, an action to establish an order, an action to establish an offer, an action to continue a sale, an action to continue an order, an action to continue an offer, an action to complete a sale, an action to complete an order and an action to complete an offer.

The financial potential can be for different roles of an organization across a list of prospects and the computer program product can further include instructions for the computer system to display the financial potential for at least one role of the organization for at least one prospect.

The computer program product can further include instructions for the computer system to group and display combinations of incentives together to allow the user to evaluate monetary benefits available for a list of prospects.

The computer program product can further include instructions for the computer system to allow the user to view multiple currently active initiatives and cross-reference the multiple currently active initiatives to a list of prospects.

The cross-reference can be an indication to the user if more than one currently active initiative exists for a specific prospect and the computer program product can further include instructions for the computer system to display the indication to the user.

The initiatives can be from multiple sources of distribution channel and the computer program product can further include instructions for the computer system to display the sources of distribution to the user.

The multiple sources of distribution channel can be at least one of, a manufacturer, a distributor, a retailer and a wholesaler and the computer program product can further include instructions for the computer system to display the manufacturer, the distributor, the retailer or the wholesaler.

The computer program product can be operated in a web-based system and no additional software is needed.

The computer program product can obtain initiative information from at least one database.

The at least one database can be a relational database.

The computer program product can further include instructions for the computer system to display prospect information and the prospect information can include a collection or a group of accounts or contacts for which an initiative is targeted.

The computer program product can operate via at least one of, a world-wide web, a local area network and a wide area network.

Other exemplary embodiments and advantages of the present disclosure may be ascertained by reviewing the present disclosure and the accompanying drawings.

### BRIEF DESCRIPTION OF THE DRAWINGS

This disclosure is further described in the detailed description which follows, in reference to the noted plurality of drawings by way of non-limiting examples of embodiments of the present disclosure, in which like reference numerals represent similar parts throughout the several views of the drawings, and wherein:

FIG. 1 shows a display screen for an exemplary electronic mail that is described in the “Interactive Smart Game Plan” disclosure, wherein a user may, by this method, receive an e-mail announcement in regards to a new product announcement, and the e-mail can link the user to the systems, methods or computer program products having an initiative analyzer according to the present system;

FIG. 2 shows a display screen as an alternative to the display screen of FIG. 1, wherein the user can directly access the systems, methods or computer program products having the initiative analyzer, according to the present disclosure;

FIG. 3 illustrates the main display screen that a user may see when he accesses the system of the “Interactive Smart Game Plan” which can take him to the initiative analyzer according to the present disclosure;

FIG. 4 illustrates a display screen that a user would see upon selecting the “My Initiatives” link which appears at the top of FIG. 3;

FIG. 5 illustrates a display screen that a user would see upon selecting the “ACME initiative” which appears at the top of the list shown in FIG. 4; and

FIG. 6 illustrates a display screen that a user would see upon selecting the “Analyze Initiative” link on the left-side navigational menu which appears in FIG. 5.

### DETAILED DESCRIPTION OF THIS DISCLOSURE

The term “salesperson(s)” is used interchangeably with the term “user(s)” herein. The user and salesperson can include any user, i.e., someone who is not an active salesperson but directs a salesperson, or any business person who may or may not be actively involved in sales but is directly or indirectly involved in the daily or intermittent operation of a company. Thus, the salesperson or user can be anyone who can use the initiative analyzer (or the initiative designer or the interactive game plan as previously discussed), systems or methods according to the present disclosure, and can benefit from such. The term “salesperson” is used in an exemplary manner and is not intended to be limited to any particular user. Thus, the usage of different terms when describing different users is not meant to limit the scope and breadth of the initiative analyzer, systems, methods or computer program products according to the present disclosure.

The term “interactive smart game plan,” “smart game plan,” “game plan,” and “plan” are used interchangeably herein and are defined according to the disclosure of U.S. patent application Ser. No. 12/055,301.

The term “prospect(s)” is defined herein as a collection or a group of accounts or contacts (individual salespersons) for which an initiative is targeted. The term is used interchangeably with the term “customer(s)” and “prospect list.” The prospect list can be derived from company owned customer/contact list, or the prospect list can be derived from the salesperson/contact list obtained elsewhere. Because of this, the salesperson can be independent of the company.

The term “initiative(s)” is used interchangeably with the terms “growth initiative(s)” and “program(s)” although each may be a subset of the other depending on the context of usage. These terms are defined herein as programs, events, and/or activities that help companies at least one of, create demand, add value throughout the sales channel, increase market share and drive revenue. Additionally, the terms can mean something that allows a user, such as a salesperson, initiate, continue, complete, execute or carry out a business transaction, such as a sale, an order, an offer, or the like, with respect to a product or a service. Exemplary activities or events that relate to this, are described in U.S. patent application Ser. Nos. 12/055,299 and 12/055,301.

As such, the term “initiative(s)” is used interchangeably with the terms “growth initiative(s),” “marketing initiative(s),” “sales initiative(s),” “marketing program(s),” and “sales program(s).” The term “initiative(s)” can mean to include one or more of these initiatives or programs as understood in the industry. Thus, the term “initiative(s)” can include anything relating to sales which is a broad description defining proactive sales programs launched by the corporation to their sales channels. When effectively launched and executed, sales initiatives offer a great opportunity for both the company and sales channel to accelerate revenue.

Where ever the term “configured to” is used herein, it is meant that the initiative analyzer, the systems, the methods and the computer program products according to the present disclosure are engineered or structured such that computer-readable instructions can be implemented to carry out specific tasks or display features as described. This term is not to be confused with the configuration systems or configuration computer programs otherwise known in the art pertaining to customizing manufactured products.

The initiative analyzer according to the present disclosure provides the ability for enterprises to effectively execute initiatives through their sales channels.

In addition to the interactive smart game plan as described in U.S. patent application Ser. No. 12/055,301, the initiative analyzer, systems, methods or computer program products according to the present disclosure can operate along with or have many features similar to those of the initiative designer as described in U.S. patent application Ser. No. 12/055,299. As described in U.S. patent application Ser. No. 12/055,299, the initiative designer can be a starting point for the interactive smart game plan, and is utilized to create, launch and track growth initiatives.

The wider advantages obtained from the present disclosure can include those described in these two disclosures, such as but not limited to:

a. Focus continually into the future of the sales processes and the ability to consistently execute, measure and improve them over time;

b. Launch growth initiatives like new products, sales campaigns, and new markets that can propel an organization forward, while leveraging the opportunities created by these key events;

c. Envision the future to include both corporate sales and independent sales channels;

d. Segment the customers by helping the salesperson to sell to the preferred prospects;

e. Draw the products and services to the customers rather than waiting for prospects to come to the dealer; f. Help the salesperson consistently communicate “the story” or pertinent information to prospects; and

g. Offer valued tools and information for use by customers and prospects in order to help build relationships and influence future purchasing decisions.

Of course, other direct benefits of the present disclosure, are possible as described above and herein.

The initiative analyzer, systems, methods or computer program products according to the present disclosure can be flexible such that it can be part of a suite of products, such as the SALES EDGE ACCELERATOR® which is described in U.S. patent application Ser. No. 12/055,299 and in U.S. patent application Ser. No. 12/055,301.

The initiative analyzer can utilize one or more databases. Preferably, the database is a relational database. Such relational databases that can be utilized or implemented are available or supplied by companies such as MICROSOFT®, ORACLE®, TERRADATA™, etc. An example of a product from MICROSOFT® that can be utilized is MICROSOFT®'s MYSQL® technology. It is to be understood that the initiative designer and other products relating to the interactive smart game plan are optional components and are not required for the initiative analyzer, systems, methods or computer program products according to the present invention. An input component such as the initiative designer can be utilized as a starting point for the interactive smart game plan or the initiative analyzer. As such, certain information and requirements of the initiatives can be inputted via the use of this particular input component or initiative designer. Other input components can be used to input other information and requirements for the game plan, initiative designer or initiative analyzer.

The initiative analyzer, systems, methods or computer program products according to the present disclosure can be implemented to operate on the web, i.e., the internet, or any other mode of communication known in the art, and can be implemented as a software-as-a-service or in an enterprise-level suite of application.

A preferred initiative analyzer according to the present disclosure can have at least the following functionalities or components. The initiative analyzer can have or utilize one or more databases, which can be the same or separate from the one or more databases of the initiative designer or the interactive smart game plan. Exemplary databases are described above.

The initiative analyzer, systems, methods or computer program products according to the present disclosure can operate with electronic mail or calendar systems. Such electronic mail and/or calendar systems that can be utilized or implemented are available or supplied by companies such as MICROSOFT, GOOGLE®, YAHOO®, EXACTTARGET® and IBM®. The technology of these systems allows the initiative activities to be communicated to the salesperson. Additionally, these systems can allow a user to access the initiative analyzer.

For example, EXACTTARGET® is a product and/or service available from EXACTTARGET® that allows client specific sub-sites and a simple programmatic interface for e-mails. This product/service can be integrated with the interactive smart game plan (and therefore also the initiative analyzer according to the present disclosure) to create client accounts within the accounts of the smart game plan/initiative analyzer and/or user logins for clients (i.e., users, marketing initiative creators, or salespersons). Clients can be setup to see their own e-mail data within the EXACTTARGET® product/service but not the data of any other clients and each of these client “sub-sites” can be branded with the initiative analyzer's look and feel (color scheme and logo) or with their own brand(s). Additionally, user accounts can be set up as a per sub-site with various permission levels being available. Creation and administration of these sites can be a manual process that will require personnel but it should be a short set-up time per customer with minimal ongoing administration.

The application programming interface (API) provided by EXACTTARGET® can include commands, formatted in xml that are transmitted to EXACTTARGET® via HTTPS called ETXML. However, a web services interface, ETWS, can also be implemented. The ETXML interface can be used to handle the tasks of creating and administering lists, subscribers, mailings, and tracking data. Using this API, an interactive smart game plan or the initiative analyzer (which can operate within the interactive smart game plan) according to the present disclosure can automate the exporting/updating of customer data from the end client to EXACTTARGET®, creating mailing lists and groups within those lists, thereby sending mailings and retrieving tracking summaries transparently to the user. The EXACTTARGET® website also has a developer portal that contains useful code samples and looks to offer good support for use of the API, both from other developers and from EXACTTARGET® technical staff.

However, other communication technologies available in the industry can be utilized and implemented.

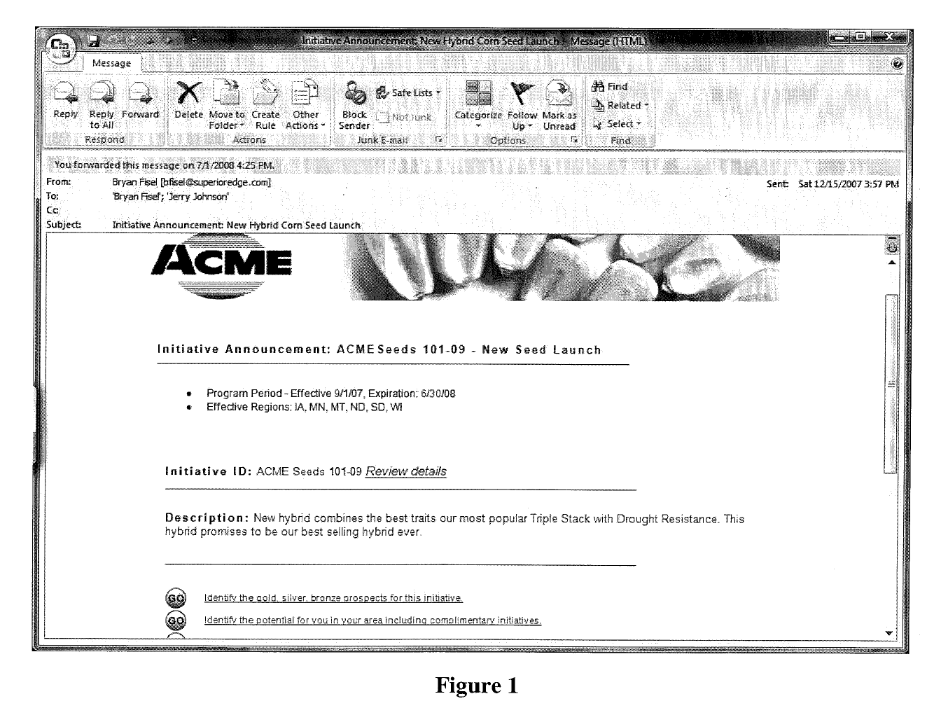

FIG. 1 shows a display screen for an exemplary electronic mail that is described in the “Interactive Smart Game Plan” disclosure, wherein a user may, by this method, receive an e-mail announcement in regards to a new product announcement, and links the user to systems and methods having an initiative analyzer according to the present system. This is one of the two options for a user to access the initiative analyzer.

This example shows an e-mail in an html format that is sent to the user via an interactive smart game plan. The user has all of the available options of a conventional e-mail. For example, the user can see the subject matter of the e-mail. In this example, the subject as shown for the e-mail is an initiative announcement for a new hybrid corn launch concerning a company called “ACME.” The contents of the e-mail can show a screen shot that is available via the interactive smart game plan. Information can be shown pertaining to the specific product or initiative, such as, but not limited to, the initiative identification (“ACME Seeds 101-09-New Seed Launch”), the effective date of the initiative, the expiration date of the initiative, the effective geographical regions for the initiative, and a brief description of the initiative. Links can be provided, such as but not limited to, one that provides further details about the initiative (“Review details”), the types of goals or game plans available for the initiative (gold, silver or bronze prospects for the initiative), the potential for the user in his area including complementary initiatives, etc.

As can be seen in FIG. 1, a link at the bottom of the screen is shown, “Identify the potential for you in your area including complementary initiatives.” This is a link to the initiative analyzer functionality of the game plan (for example, from the SALES EDGE ACCELERATOR® application that is available from Superior Edge®). The text for this link can vary and other ways to access the initiative analyzer are possible, such as a graphical button instead of a link.

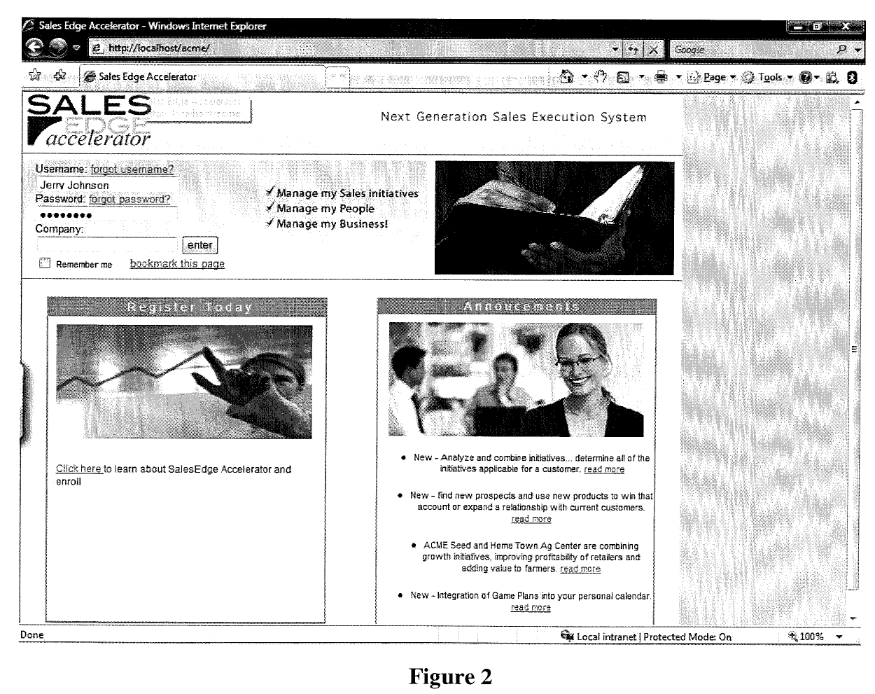

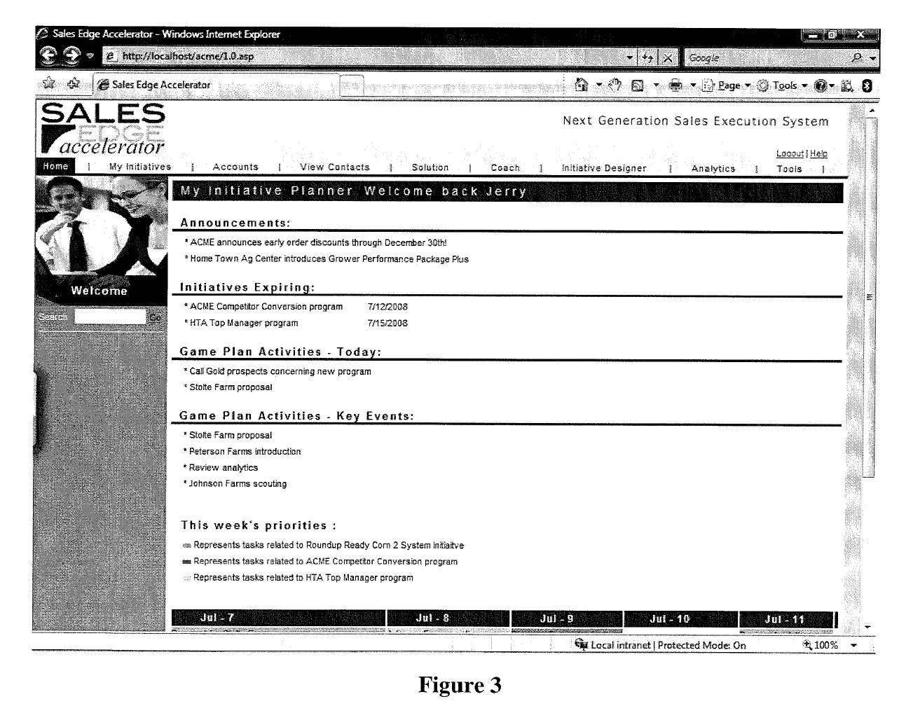

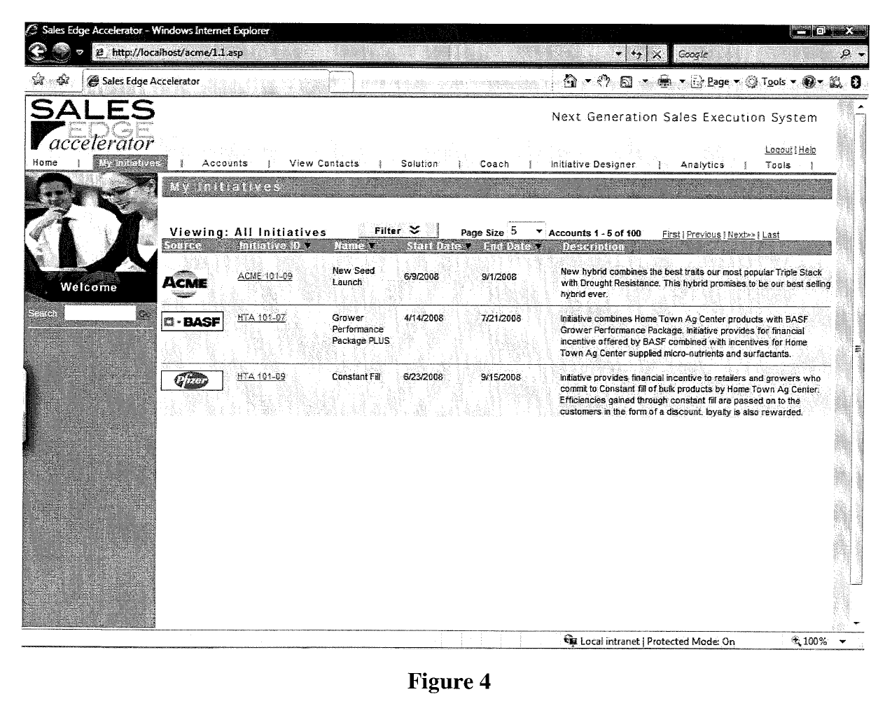

Another way for the user to access the initiative analyzer can be through accessing directly via the SALES EDGE ACCELERATOR® application as shown in FIGS. 2 and 3, which are further described below. By accessing the initiative analyzer in either way, the user will be able to view specific information for the initiative analyzer, such as those shown in FIGS. 4-6, which are further described below.

As such, FIG. 2 shows a display screen as an alternative to the display screen of FIG. 1, wherein the user can directly access the systems and methods having the initiative analyzer, according to the present disclosure. Here, a user can enter his user name and password to gain entry to the system. From this method, the user can see features and functionality of the smart game plan as depicted in the figure. However, certain initiatives can be shown in this figure and the initiative for ACME (as an example shown in FIG. 1), is shown in FIG. 2. A link is provided in this display screen to take the user to this initiative.

FIG. 3 illustrates the first screen or main display screen a user will see once he has logged in via the screen shown in FIG. 2. This screen can provide additional information that an interactive smart game plan such as the that of the SALES EDGE ACCELERATOR®. At the top of the screen, there is provided a “My Initiative” tab that allows the user to link to the initiative analyzer.

FIG. 4 illustrates a display screen that the user would see upon selecting the “My Initiatives” link which appears at the top of FIG. 3. Here, the user can see a list of relevant initiatives. Certain information pertaining to each initiative can be shown, such as but not limited to, the initiative identification, the name of the initiative, the start date of the initiative, the end or expiration date of the initiative, and a brief description of the initiative.

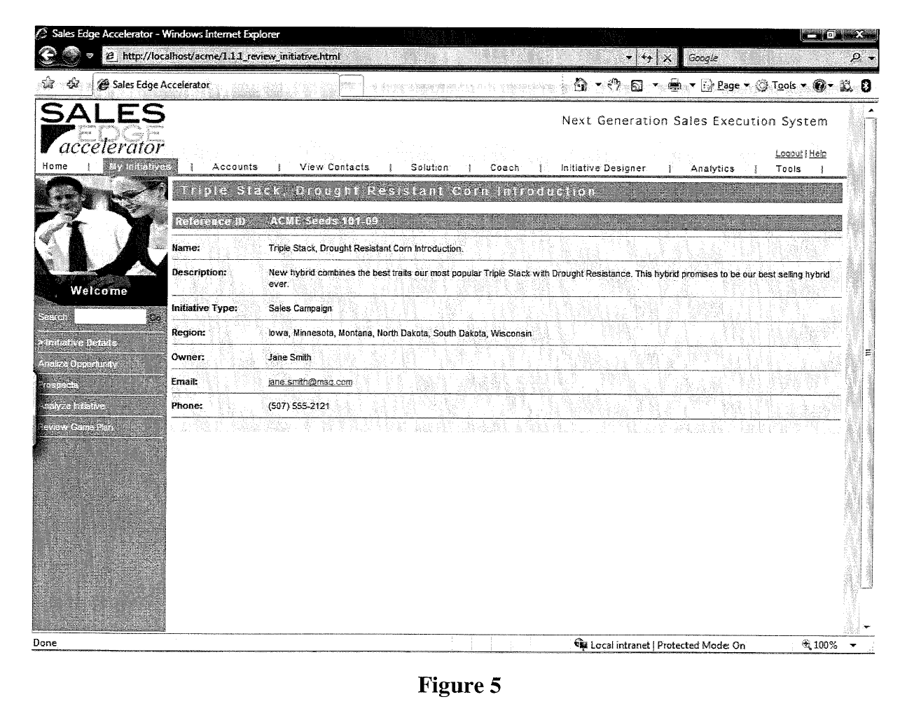

FIG. 5 illustrates a display screen that a user would see upon selecting the “ACME initiative” which appears at the top of the list shown in FIG. 4. In this example, additional information relevant to the ACME initiative can be shown, such as but not limited to the initiative identification, the name of the initiative, the description of the initiative, the initiative type, the geographical regions in which the initiative applies, the owner or the initiative, e-mail contact information and phone contact information. Other displays of information are possible.

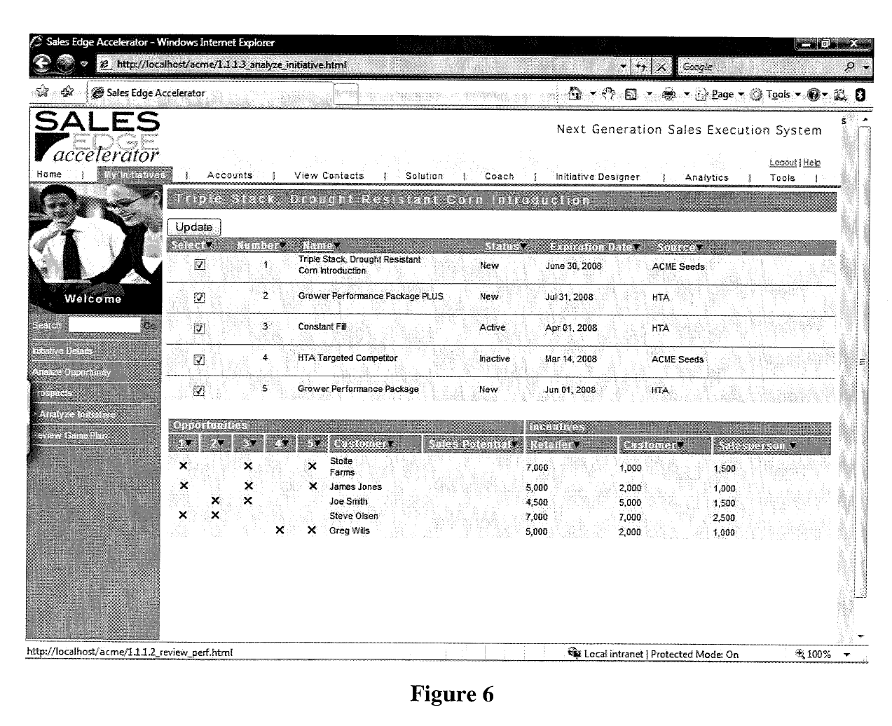

FIG. 6 illustrates a display screen that a user would see upon selecting the “Analyze Initiative” link on the left-side navigational menu which appears in FIG. 5. The top section of this screen illustrates a list of current initiatives being offered by multiple sources. In this example, there are five initiatives listed from two different sources (HTA and ACME Seeds). These five initiatives could be the same type of information that a retail dealership would maintain. However, the electronic display of information, access of information and contents of the display screen provide many benefits. For example, the bottom half of this screen illustrates the analysis that is performed by the initiative analyzer, such as but not limited to, the determination for each customer or prospect of which initiatives apply to the customer or prospect and also the value of the combined initiatives for different entities, such as the retail dealership, the salesperson and the customer.

Returning to the top section of the screen, a “Select” button and column is shown. This column shows a list of checked boxes which indicate whether the initiative is being considered in the analysis section below (as shown in the table at the bottom of the screen). If the user unselects one of the initiatives, the table below would update and not include that initiative in the analysis. The “number” column as shown in the top half of the screen, provides a numeric identifier assigned by the initiative analyzer that is used for referencing the initiatives. The “name” column provides the name of the initiative while the “status” column is used to indicate the status of each initiative. Examples of the status of the initiatives can be but not limited to, active, new and inactive. The “expiration date” column displays the expiration date of the initiative and the “source” column displays the creator of the initiative (creator being the organization that has launched the initiative).

As can be seen in this screen, the initiative analyzer provides a wealth of information regarding either specific initiatives or a group of initiatives at a glance by the user. Information can be provided based on needs and desired organization. Calculations of different values are possible.

For example, the table can show the opportunities available for the user in terms of each initiative. In the example shown in FIG. 6, the example specific for Stolte Farms, a user can see that initiative numbers 1, 3 and 5 are available for this customer. Values for the sales potential can be shown. Specific incentives for the retailer, the customer and the salesperson are calculated and can be shown. Thus, the example shown in this figure allows a user to overcome all of the problems that a salesperson normally faces daily as previously discussed.

As can be seen in the screen shot of FIG. 1, the initiative analyzer can operate as a web-based application. Thus, all of the features of WINDOWS INTERNET EXPLORER® and GOOGLE® can be utilized as are well-known and are not discussed herein. Additionally, all of the buttons, display features and functional elements described or shown in the screen shots that appear in U.S. patent application Ser. Nos. 12/055,299 and 12/055,301 can also be used in the screen shots for the initiative analyzer according to the present invention, and will not be discussed herein. For example, all of the menu items and screen navigations can be the same as those described in the disclosures of U.S. patent application Ser. Nos. 12/055,299 (“Initiative Designer”) and 12/055,301 (“Interactive Smart Game Plan”).

Embodiments of the present disclosure can be applied in the context of a computer system. The system can include a conventional personal computer, including a processing unit, a system memory and a system bus that couples the system memory to the processing unit. System memory includes read only memory (ROM) and random access memory (RAM). A basic input/output system (BIOS) containing the basic routines that help to transfer information between elements within the personal computer, is stored in the ROM.

Embodiments of the present invention can be applied in the context of computer systems other than the personal computer. These computer systems can include handheld and/or wireless devices (such as, but not limited to, wireless PDA (personal digital assistant) cell phones, PALM PILOT® devices, other PDA devices, and the like), multiprocessor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present disclosure may be accomplished utilizing either local or remote storage devices, or simultaneously utilizing both local and remote storage devices.

The personal computer can further include a hard disc drive, a magnetic disc drive, and an optical disc drive. A magnetic disc drive can be utilized to read from or to write to a removable disc. An optical disc drive can be utilized for reading data from (or writing data to) an optical media, such as a CD-ROM disc. The hard disc drive, magnetic disc drive and optical disc drive can be connected to the system bus by a hard disc drive interface, a magnetic disc drive interface, and an optical disc drive interface, respectively. The drives and their associated computer-readable media can provide nonvolatile storage for the personal computer. Other types of media that are readable by a computer may also be used in the operation environment.

A number of program modules can be stored in the drives and the RAM, including an operating system, one or more application programs, other program modules and program data. In particular, one of the other programs modules can be any of the components described above that demonstrate certain features and embodiments of the present disclosure.

Input devices can include a keyboard and a mouse (or other pointing devices) and can be operably connected to the system bus through a serial port interface that is coupled to the system bus. Input devices could be connected utilizing other interfaces such as a universal serial bus (USB). A monitor can be connected to the system bus through a video adapter. Other peripheral output devices (e.g., speakers or printers) can also be included. Other configurations of the system than those described above are possible.

The systems and methods according to the present disclosure can be implemented such that they can be functional via a world-wide web, a local area network or a wide area network. Accordingly, a computer program product readable by a computer system having computer-executable instructions that when executed cause a processor of the computer system to generate one or more of the personal electronic mails in the execution of activities in an interactive smart game plan for one or more growth initiatives can be utilized for the systems and methods according to the present disclosure.

For example, the personal computer can operate in a network environment utilizing connections to one or more remote computers. The remote computer can be a server, a router, a peer device, or other common network nodes. The remote computer can include many or all of the features and elements described in relation to any personal computer. The network connections can include a local area network (LAN) and/or a wide area network (WAN).

For example, the personal computer can be connected to the LAN through a network interface. The personal computer can also be connected to the WAN and can include a modem for establishing communications over the WAN. The modem, which can be internal or external, and can be connected to the system bus via the serial port interface. However, any other methods of communications that are different from a modem and are available in the art can be used.

In a networked environment, program modules relating to one or more computer readable products containing one or more components of the interactive smart game plan, or portions thereof, can be stored in a remote memory storage device. For example, application programs can be stored utilizing a memory storage device that carry instructions to execute according to the smart game plan or that demonstrates certain features and embodiments of the present disclosure. It will be appreciated that the network connections described above are exemplary and other methods for establishing a communications link between the computers, such as a wireless interface communications link, can be used.

Notwithstanding the broad applicability of the principles of the disclosure described above, it should be understood that the configuration of the exemplary embodiments as an application program that is stored on, and enables data to be stored on, a remote computer provides significant advantages although the systems, methods and computer readable products as described above, already provide significant advantages in assisting a salesperson to directly connect the growth initiative to the sales and the execution of the growth initiative.

Thus, the initiative analyzer, methods, systems and computer readable program product according to the present disclosure provide a wide array of benefits. They allow a salesperson not only to focus on launching products to sales channels, but also to launch sales campaigns targeted at a particular market segment, launch existing products into new markets, and launch new channel organizations and territories. They also allow the salesperson to expand his or her focus to include the launch of a wide variety of initiatives as described. Thus, the methods and products according to the present disclosure allow the salesperson to launch these initiatives in a meaningful way. In doing so, the initiative not only can generate revenue but can also provide secondary benefits, such as, creating a stronger channel network and developing a greater channel mindshare and loyalty.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description taken with the drawings making apparent to those skilled in the art how the several forms of the present disclosure may be embodied in practice.

It is noted that the foregoing examples have been provided merely for the purpose of explanation and are in no way to be construed as limiting of the present disclosure. While the present disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed:

1. A system for electronically determining the financial potential for a user for one or more initiatives comprising:
an electronic component configured to display a list of one or more initiatives for one or more prospects and financial potential for the one or more initiatives of each prospect.

2. The system of claim 1, wherein the electronic component is configured to, at least one of:
(a) allow a user to determine which activities, events or terms of the one or more initiatives to complete in order to maximize sales potential;
(b) allow a user to evaluate information categorized by prospects or initiatives; and
(c) view and evaluate the financial potential for a specific prospect from the list of the one or more initiatives.

3. The system of claim 1, wherein the financial potential comprises at least one of, an incentive, a compensation, a reward and a bonus and the electronic component is configured to display at least one of, the incentive, the compensation, the reward and the bonus.

4. The system of claim 1, wherein the one or more prospects is a customer, the user is a salesperson and the electronic component is configured to display at least one of, the financial potential for the salesperson and the financial benefits for the customer.

5. The system of claim 2, wherein the activities, events or terms of the one or more initiatives comprise at least one of, an action to establish a sale, an action to establish an order, an action to establish an offer, an action to continue a sale, an action to continue an order, an action to continue an offer, an action to complete a sale, an action to complete an order and an action to complete an offer.

6. The system of claim 1, wherein the financial potential is for different roles of an organization across a list of prospects and the electronic component is configured to display the financial potential for at least one role of the organization for at least one prospect.

7. The system of claim 1, wherein the electronic component is configured to group and display combinations of incentives together to allow the user to evaluate monetary benefits available for a list of prospects.

8. The system of claim 1, wherein the electronic component is configured to allow the user to view multiple currently active initiatives and cross-reference the multiple currently active initiatives to a list of prospects.

9. The system of claim 8, wherein the cross-reference is an indication to the user if more than one currently active initiative exists for a specific prospect and the electronic component is configured to display the indication to the user.

10. The system of claim 1, wherein the initiatives are from multiple sources of distribution channel and the electronic component is configured to display the sources of distribution to the user.

11. The system of claim 10, wherein the multiple sources of distribution channel are at least one of, a manufacturer, a distributor, a retailer and a wholesaler and the electronic component is configured to display the manufacturer, the distributor, the retailer or the wholesaler.

12. The system of claim 1, wherein the electronic component is configured for a web-based system and no additional software is needed.

13. The system of claim 1, wherein the electronic component is configured to obtain initiative information from at least one database.

14. The system of claim 1, wherein the at least one database is a relational database.

15. The system of claim 1, wherein the electronic component is configured to display prospect information and the prospect information comprises a collection or a group of accounts or contacts for which an initiative is targeted.

16. The system of claim 1, wherein the electronic component is configured to operate via at least one of, a world-wide web, a local area network and a wide area network.

17. A method for analyzing one or more initiatives by one or more users comprising:
providing a system comprising an electronic component configured to display a list of one or more initiatives for one or more prospects and financial potential for the one or more initiatives of each prospect; and
utilizing the system for electronically determining the financial potential for one or more initiatives.

18. The method of claim 17, further comprising, at least one of:
(a) determining which activities, events or terms of the one or more initiatives to complete in order to maximize sales potential by using the system;
(b) evaluating information categorized by prospects or initiatives by using the system; and
(c) viewing and evaluating the financial potential for a specific prospect from the list of the one or more initiatives by using the system.

19. The method of claim 17, wherein the financial potential comprises at least one of, an incentive, a compensation, a reward and a bonus and further comprising utilizing the electronic component to display at least one of, the incentive, the compensation, the reward and the bonus.

20. The method of claim 17, wherein the one or more prospects is a customer, the user is a salesperson and further comprising utilizing the electronic component to display at least one of, the financial potential for the salesperson and the financial benefits for the customer.

21. The method of claim 18, wherein the activities, events or terms of the one or more initiatives comprise at least one of, an action to establish a sale, an action to establish an order, an action to establish an offer, an action to continue a sale, an action to continue an order, an action to continue an offer, an action to complete a sale, an action to complete an order and an action to complete an offer.

22. The method of claim 17, wherein the financial potential is for different roles of an organization across a list of prospects and further comprising utilizing the electronic component to display the financial potential for at least one role of the organization for at least one prospect.

23. The method of claim 17, further comprising utilizing the electronic component to group and display combinations of incentives together to allow the user to evaluate monetary benefits available for a list of prospects.

24. The method of claim 17, further comprising utilizing the electronic component to allow the user to view multiple currently active initiatives and cross-reference the multiple currently active initiatives to a list of prospects.

25. The method of claim 24, wherein the cross-reference is an indication to the user if more than one currently active initiative exists for a specific prospect and further comprising utilizing the electronic component to display the indication to the user.

26. The method of claim 17, wherein the initiatives are from multiple sources of distribution channel and further comprising utilizing the electronic component to display the sources of distribution to the user.

27. The method of claim 26, wherein the multiple sources of distribution channel are at least one of, a manufacturer, a distributor, a retailer and a wholesaler and further comprising utilizing the electronic component to display the manufacturer, the distributor, the retailer or the wholesaler.

28. The method of claim 17, wherein the electronic component is operated in a web-based system and no additional software is needed.

29. The method of claim 17, wherein the electronic component obtains initiative information from at least one database.

30. The method of claim 29, wherein the at least one database is a relational database.

31. The method of claim 17, further comprising utilizing the electronic component to display prospect information and the prospect information comprises a collection or a group of accounts or contacts for which an initiative is targeted.

32. The method of claim 17, wherein the electronic component operates via at least one of, a world-wide web, a local area network and a wide area network.

33. A computer program product readable by a computer system having computer-executable instructions that when executed cause a processor of the computer system to display information and/or analyze one or more initiatives, the computer program product instructing the computer system to:
electronically display a list of one or more initiatives for one or more prospects and financial potential for the one or more initiatives of each prospect; and
electronically determine the financial potential for one or more growth initiatives.

34. The computer program product of claim 33, further comprising instructions for the computer system to, at least one of:
(a) determine which activities, events or terms of the one or more initiatives to complete in order to maximize sales potential;
(b) evaluate information categorized by prospects or initiatives; and
(c) evaluate and display the financial potential for a specific prospect from the list of the one or more initiatives.

35. The computer program product of claim 33, wherein the financial potential comprises at least one of, an incentive, a compensation, a reward and a bonus and further comprising instructions for the computer system to display at least one of, the incentive, the compensation, the reward and the bonus.

36. The computer program product of claim 33, wherein the one or more prospects is a customer, the user is a salesperson and further comprising instructions for the computer system to display at least one of, the financial potential for the salesperson and the financial benefits for the customer.

37. The computer program product of claim 34, wherein the activities, events or terms of the one or more initiatives comprise at least one of, an action to establish a sale, an action to establish an order, an action to establish an offer, an action to continue a sale, an action to continue an order, an action to continue an offer, an action to complete a sale, an action to complete an order and an action to complete an offer.

38. The computer program product of claim 33, wherein the financial potential is for different roles of an organization across a list of prospects and further comprising instructions for the computer system to display the financial potential for at least one role of the organization for at least one prospect.

39. The computer program product of claim 33, further comprising instructions for the computer system to group and display combinations of incentives together to allow the user to evaluate monetary benefits available for a list of prospects.

40. The computer program product of claim 33, further comprising instructions for the computer system to allow the user to view multiple currently active initiatives and cross-reference the multiple currently active initiatives to a list of prospects.

41. The computer program product of claim 40, wherein the cross-reference is an indication to the user if more than one currently active initiative exists for a specific prospect and further comprising instructions for the computer system to display the indication to the user.

42. The computer program product of claim 33, wherein the initiatives are from multiple sources of distribution channel and further comprising instructions for the computer system to display the sources of distribution to the user.

43. The computer program product of claim 42, wherein the multiple sources of distribution channel are at least one of, a manufacturer, a distributor, a retailer and a wholesaler and further comprising instructions for the computer system to display the manufacturer, the distributor, the retailer or the wholesaler.

44. The computer program product of claim 33, wherein the computer program product is operated in a web-based system and no additional software is needed.

45. The computer program product of claim 33, wherein the computer program product obtains initiative information from at least one database.

46. The computer program product of claim 45, wherein the at least one database is a relational database.

47. The computer program product of claim 33, further comprising instructions for the computer system to display prospect information and the prospect information comprises a collection or a group of accounts or contacts for which an initiative is targeted.

48. The computer program product of claim 33, wherein the computer program product operates via at least one of, a world-wide web, a local area network and a wide area network.
